(19) United States
(12) Patent Application Publication
(10) Pub. No.: US 2025/0194638 A1
(43) Pub. Date: Jun. 19, 2025

(54) PROCESS FOR THE PRODUCTION OF A STRUCTURED PROTEIN PRODUCT

(71) Applicant: CONOPCO, INC., D/B/A UNILEVER, Englewood Cliffs, NJ (US)

(72) Inventors: Luuk Christianus Hubertus BEEKMANS, Wageningen (NL); Marianna CHRISTAKI, Wageningen (NL); Kristel Maria Hélène DONNERS, Wageningen (NL); Dylan Jonathan EDWARDS, Wageningen (NL); Martin Paulus Johannes SCHREIBER, Wageningen (NL)

(73) Assignee: CONOPCO, INC., D/B/A UNILEVER, Englewood Cliffs, NJ (US)

(21) Appl. No.: 18/843,752

(22) PCT Filed: Mar. 29, 2023
(86) PCT No.: PCT/EP2023/058135

§ 371 Date: Sep. 4, 2024

(30) Foreign Application Priority Data
Mar. 30, 2022 (EP) 22165602.8

(51) Int. Cl. A23J 3/26; A23J 3/14

(52) U.S. Cl. CPC A23J 3/26; A23J 3/14

(57) ABSTRACT

The invention provides a process for the production of a structured protein product using an apparatus, the apparatus comprising a nozzle element and a forming element wherein:
i) the nozzle element comprises an opening (1); ii) the forming element comprises one or more cavities (4) recessed relative to the forming element surface (5); and iii) the nozzle element and forming element are moveable relative to each other such that: in a closed configuration, the opening (1) is blocked by the surface (5); and in an open configuration, the opening (1) is at least partially aligned with a cavity (4),
the process comprising the steps of:
a) moving the nozzle element and forming element relative to each other such that the opening (1) comes into at least partial alignment with the one or more cavities (4) thereby to configure the opening (1) in the open configuration;
b) pumping a protein-containing (6) material into the cavity (4) via the opening (1) thereby to form the structured protein product (8) within the cavity (4);
c) moving the nozzle element and forming element relative to each other such that the opening (1) comes into alignment with the surface (5) of the forming element thereby to configure the opening (1) in the closed configuration; and then
d) removing the structured protein product (8) from the cavity (4).

### FIELD OF THE INVENTION

The present invention relates to a process for the production of a structured protein product. In particular, the process provides a product that contains no animal derived components yet still has similar, or the same, characteristics and/or properties as the animal derived product that it is intended to replace. In particular, the process provides a product that has protein fibres which are aligned in a way that is analogous to the structure of the muscle fibres of the animal derived product that it is intended to replace.

### BACKGROUND OF THE INVENTION

Meat is considered the highest quality protein source, not only due to its nutritional characteristics, but also for its appreciated taste. Meat is nutritious because meat protein contains all essential amino acids for humans. In addition, meat comprises essential vitamins, such as vitamin B12, and is rich in minerals. Meat also contains muscle tissue which greatly contributes to food acceptability by imparting specific characteristics such as appearance, texture, and mouthfeel. The muscle tissue also contributes to the properties of the meat as it is prepared and cooked, for example in the way it shrinks, undergoes colour change during cooking, and relaxes after cooking.

However, due to animal diseases such as mad cow disease, a global shortage of animal protein, growing consumer demand for religious (halal or kosher) food, and for economic reasons, there is an increased need for alternatives to meat products.

Meat analogues are prepared such that they resemble meat as much as possible in appearance, taste and texture. Meat analogues are typically prepared from proteinaceous fibres of non-animal origin. Proteinaceous fibres, such as texturized vegetable protein, are characterized by having an identifiable structure and a structural integrity, such that each unit will withstand hydration, cooking and other procedures used in preparing the fibres for consumption.

The present innovation seeks to help consumers move away from animal based diets to meat analogues. It is widely accepted that such a change in consumption is beneficial in many ways. The meat industry is detrimental to the environment and is hugely inefficient compared to the production of crops for plant based diets. Moreover, animal derived fat tissues are known to contain components such as cholesterol and saturated fats which are a significant health risk factor whereas non-animal based food products are healthier, and moreover can be produced far more efficiently and in a sustainable and environmentally acceptable manner.

Although many consumers are motivated to independently move to a plant based diet, other consumers face significant challenges when giving up animal based foodstuffs. A central challenge for providing acceptable non-animal based foodstuffs (also referred to herein as meat analogues) is to ensure they mimic as closely as possible the animal based foodstuffs they are replacing. As will be appreciated however, meats are derived from animals and it is not straightforward to provide non-animal alternatives. Meat products are made from the muscle tissue of animals and as such the complex structure of the protein-based part of the tissue (i.e. the connective muscle fibres) is crucial to the properties of the meat and this needs to be replicated in non-animal alternatives.

Muscle structure is hierarchically organized consisting of a complex architecture. The structured network in the muscles is responsible for the typical structure in meat. The solid material of the muscle contains about 70% of protein. The complex mixture of the proteins in the muscle consists for the largest part of fibrous proteins, that give the meat its typical structure. The muscle fibres are covered with a coarser connective tissue membrane (the perimysium) and surrounded by connective tissue, that contains collagen and elastin. The muscle fibres consist of myofibrils that are made up by myofilaments. These myofilaments are composed of sarcomeres, which are made up from the myosin and actin proteins. Myosin forms thick filaments, while actin forms thin filaments. The sensory and quality attributes of meat are mainly related to these structural elements.

The objective of this invention is to provide a structured protein product from non-animal components that closely mimics animal derived tissues and muscle structure in terms of its characteristics and properties. Moreover, the product must also be suitable as a meat analogue or for use in the manufacture of meat analogues, for example it must be processable under the same conditions as any other components of meat analogues and must adhere to and/or integrate with those other components during manufacture, storage, transport, cooking, and consumption.

Providing a structured protein product that closely mimics animal tissue is particularly challenging because animal muscle tissue is an extremely complex, organically grown tissue, that contains connective tissue in a fibrillar network of proteins. It is this complex structure that delivers the properties that consumers expect from meat-based foodstuffs and it something that is very difficult to reproduce in non-animal based products. Of particular importance in delivering an acceptable structured protein product is the provision of aligned fibres, especially protein fibres, that mimic as closely as possible the organoleptic properties of the protein fibres in the animal muscle tissues.

The prior art provides examples of previous attempts at delivering structured protein products with aligned fibres.

US2007269567 discloses a process for producing a restructured meat composition, the process comprising: extruding a plant protein material under conditions of elevated temperature and pressure through a die assembly to form a structured plant protein product having protein fibres that are substantially aligned. US2008254199 discloses a process for producing a colored structured protein product having protein fibres that are substantially aligned, the process comprising: a. combining a protein material with at least one colorant to form a blended protein mixture; and b. extruding the blended protein mixture under conditions of elevated temperature and pressure through a die assembly to form a colored structured protein product comprising protein fibres that are substantially aligned. US2009208633 discloses a granular composition, comprising; (A) a hydrated plant protein material and (B) a hydrated structured protein material having protein fibres that are substantially aligned; wherein the weight ratio of (A) to (B) is between about 1.5 and about 5 to about 1 to produce a granular composition having a particle size of between about 2 millimeters and about 10 millimeters. US2010074989 discloses a process for the preparation of hierarchical fibrous food structures, comprising subjecting an edible protein suspension to simple shear flow and enzymatic cross-linking during shearing. These disclosures utilise die assemblies.

US2012207904 claims a process for producing a structured protein product, the process comprising: extruding at least one gluten-free protein material and a binding agent through a die assembly to form a structured protein product having protein fibres that are substantially aligned. US2021100263 claims a high-throughput continuous extrusion process for the manufacture of a fibrous-textured high-moisture protein foodstuff having organoleptic qualities comparable to cooked muscle meat, said process including the steps of: preparing a blend of dry proteinaceous materials and/or a stream of wet protein material; then feeding said blend into a feed port of an extrusion cooker, in conjunction with water, in a ratio of between 18 percent-53 percent dry proteinaceous materials to between 6 percent-70 percent water, wherein said combination has a protein content of greater than 15 percent and a fat content of less than 10 percent; wherein said extrusion cooker is preferably a twin-screw co-rotating type with a heated barrel and a feed port adapted to receive said blend and water; and wherein the feed port of the extrusion cooker is configured such that at least part of the proteinaceous material and water enter the extrusion cooker in the same position relative to the length of the extruder barrel, but also such that said proteinaceous material and water enter the extrusion cooker in a position offset from the centreline in such a way as to be moved immediately downstream of the water by the screw flights; then continuously transferring the output of said extrusion cooker to a cooling die that is adapted to cool the extrudate such that a fibrous internal alignment of proteins forms in the extrudate; then transferring the cooled extrudate to a mechanical size reduction device adapted to tenderise and shred the extrudate in to pieces of a consistent size distribution. Both disclosures utilise extrusion.

WO21095034 discloses a method of producing a meat substitute the method comprising: introducing into a printer head of a digital printer protein-containing material; and operating the digital printer to dispense onto a printer bed a single convoluted protein containing strand or a plurality of individual protein containing strands, the single strand being folded or the plurality of said strands being arranged such that segments between folds of the single strand or the plurality of strands are essentially parallel along their longitudinal axis; wherein the protein containing strand comprises texturized protein; and wherein at least a portion of the texturized protein comprises elongated fibres having a length above 5 mm.

U.S. Ser. No. 11/241,024 discloses a process for producing fibrous meat analogues, comprising: subjecting an ingestible polysaccharide hydrogel to directional freezing inducing formation of aligned elongated ice crystals to form a directionally frozen polysaccharide hydrogel with aligned channels in which the aligned elongated ice crystals are located; thawing the directionally frozen polysaccharide hydrogel with the aligned channels by immersing the frozen ingestible polysaccharide hydrogel in a solution containing at least one ingestible soluble heat gelling protein, thereby melting and replacing the aligned elongated ice crystals with the at least one ingestible soluble heat gelling protein at a temperature below the gelling temperature of the soluble heat gelling protein, to produce a protein infused polysaccharide hydrogel, wherein protein loading varies based on the immersing time; and heating the protein infused ingestible polysaccharide hydrogel at a temperature above the gelling temperature of the at least one ingestible soluble heat gelling protein to create protein fibres to form a fibrous meat analogue food product.

Despite the foregoing, there is a requirement for an improved approach for the production of structured protein products. The present inventors have now found through extensive research a new process for the production of a structured protein product that delivers products with excellent fibre alignment. Moreover, not only is the process capable of delivering products with aligned fibres, it has been found that the properties of these fibres are maintained, and even enhanced during processing.

### SUMMARY OF THE INVENTION

In a first aspect, the present invention therefore provides a process for the production of a structured protein product. As used herein, the term structured protein product means that the protein fibres are aligned as set out below. The resulting product may contain no animal derived components yet still has similar, or the same, characteristics and/or properties as the animal derived product that it is intended to replace. The process actually provides a product that has protein fibres which are aligned in a way that is analogous to the structure of the muscle fibres of the animal derived product that it is intended to replace. The process also provides for the maintenance of protein fibre length and can even deliver increases in protein fibre length.

The process of first aspect uses an apparatus, the apparatus comprising a nozzle element and a forming element wherein:
i) the nozzle element comprises an opening (1);
ii) the forming element comprises one or more cavities (4) recessed relative to the forming element surface (5); and
iii) the nozzle element and forming element are moveable relative to each other such that
   in a closed configuration, the opening (1) is blocked by the surface (5), and
   in an open configuration, the opening (1) is at least partially aligned with a cavity (4),
the process comprising the steps of:
a) moving the nozzle element and forming element relative to each other such that the opening (1) comes into at least partial alignment with the one or more cavities (4) thereby to configure the opening (1) in the open configuration;
b) pumping a protein-containing (6) material into the cavity (4) via the opening (1) thereby to form the structured protein product (8) within the cavity (4);
c) moving the nozzle element and forming element relative to each other such that the opening (1) comes into alignment with the surface (5) of the forming element thereby to configure the opening (1) in the closed configuration; and then
d) removing the structured protein product (8) from the cavity (4).

Preferably the opening has an aspect ratio of from 1:100 to 100:1.

Preferably the width of the opening (1) is at least 100% of the widest part of the cavity (4) of the forming element.

Preferably the nozzle element comprises a sealing element (2).

Preferably the forming element is in the form of a cylinder with a horizontal axis of rotation having a plurality of cavities located on the outer face of the cylinder.

Preferably the protein-containing material comprises from 1 to 65 wt % protein.

Preferably the protein-containing material comprises no animal protein.

Preferably the protein-containing material comprises from 1 to 20 wt % binder.

Preferably the protein-containing material comprises from 0.5 to 15 wt % of fat or oil.

Preferably the protein fibres forming the structured protein product are contiguous to each other at less than a 45 degree angle.

Preferably at least 25% of the protein fibres are contiguous to each other.

In a second aspect, the invention provides a structured protein product directly obtained from the process of the first aspect.

In a third aspect, the invention provides the use of the product of the second aspect for the manufacture of meat replacement products.

In a third aspect, the invention provides a meat replacement product comprising the product of the second aspect.

### FIGURES

FIG. 1 shows a version of a nozzle element for use in the present invention.

FIG. 2 shows a version of a forming element for use in the present invention.

FIG. 3 shows apparatuses configured for batch production.

FIG. 4 shows apparatuses configured for continuous production.

FIG. 5 exemplifies the process of the invention.

### DETAILED DESCRIPTION OF THE INVENTION

The present invention provides a novel and improved process for the production of a structured protein product. The resulting product need contain no animal derived components yet still has similar, or the same, characteristics and/or properties as the animal derived product that it is intended to replace. The process actually provides a product that has protein fibres which are aligned in a way that is analogous to the structure of the muscle fibres of the animal derived product that it is intended to replace.

The process also provides for the maintenance of protein fibre length and can even deliver increases in the protein fibre length.

### Apparatus

The process of the invention uses an apparatus comprising a nozzle element and a forming element.

### Nozzle Element

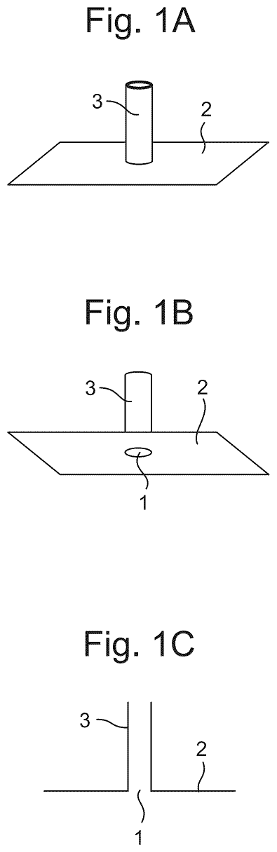

FIG. 1 shows a version of a nozzle element for use in the present invention A) in perspective from above, B) in perspective from below, and C) in cross-section. The nozzle element comprises an opening (1). The nozzle element may also comprise a sealing element (2) and a conduit (3) such as a pipe, tube, or similar through which the protein-containing material can be passed to the opening (1).

### Opening

The opening (1) may be of any suitable size and/or shape. For example, the opening (1) may be circular, ovoid, or rectangular. It may preferably have an aspect ratio of from 1:100 to 100:1, more preferably from 1:75 to 75:1, more preferably still from 1:50 to 50:1, even more preferably from 1:25 to 25:1, yet more preferably from 1:10 to 10:1, even more preferably still from 1:5 to 5:1, yet more preferably still from 1:2.5 to 2.5:1, preferably about 1:1.

The width of the opening (1) is measured as the widest point perpendicular to the direction of movement of the nozzle element relative to the forming element. The opening (1) may be sized such that it is the same width, or approximately the same width, or wider than the widest part of the cavity of the forming element (the widest part of the cavity being measured as the widest point perpendicular to the direction of movement of the nozzle element relative to the forming element).

Preferably, the width of the opening is at least 100% of the widest part of the cavity of the forming element, more preferably at least 125%, even more preferably at least 150%, even more preferably still at least 200%.

Alternatively, the width of the opening is less than 100% of the widest part of the cavity of the forming element, preferably less than 75%, more preferably less than 50%, even more preferably less than 25%.

The size and shape of the opening (1) may correspond to the opening of the cavity. For example, if the cavity is shaped to form a round burger product, then the opening (1) may have a circular shape to correspond to the circular shape of the opening of the cavity. Or alternatively, if the cavity is shaped to form a chicken fillet product, then the opening (1) may have a chicken fillet shape that corresponds to the cross-sectional chicken fillet shape of the cavity.

However, an advantage of the process is that the opening (1) does not need to be any particular shape and can simply be an opening that is large enough to allow the protein-containing material to be pumped into the cavity.

### Sealing Element

The nozzle element may optionally comprise a sealing element (2) such as that shown in FIG. 1. Such a sealing element (2) is capable of sealing the cavity of the forming element.

The sealing element (2) may be any suitable size and/or shape. However, it will be appreciated that such a sealing element (2) is preferably of a size and shape such that it will cover the cavity until such time as the opening (1) of the nozzle is no longer in the open configuration.

The nozzle element may be of any suitable material such as stainless steel, plastic, or other such materials. Preferably it is constructed from a flexible but resilient material such as polypropylene.

### Forming Element

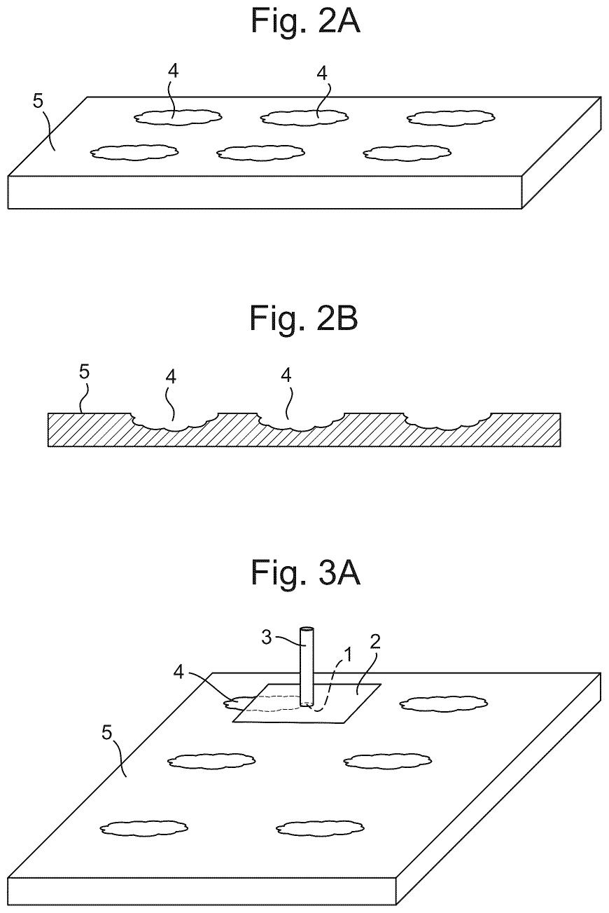

FIG. 2 shows a version of a forming element for use in the present invention A) in perspective from above, and B) in cross-section. The forming element comprises one or more cavities (4) that are recessed into the forming element relative to the surface (5) of the forming element.

The forming element may be of any suitable material such as stainless steel, plastic, or other such materials. The cavities may be of a different material to the rest of the forming element. The forming element, and hence the cavities (4), may be temperature controlled in order to heat or cool the protein-containing material that is pumped into the cavities (4).

### Cavities

The forming element comprises one or more cavities (4), preferably the forming element comprises a plurality of cavities (4).

The cavities (4) may be of any suitable shape. Preferably the cavities (4) correspond with the shape of the structured protein product that is to be produced in the process. For example, if the process is to deliver animal free alternatives for whole muscle cuts, then the cavities (4) will correspond to a steak shape, or a chicken fillet, or a pork fillet, or similar. Alternatively, if the process is to deliver animal free alternatives to shaped processed meat products such as those made from mince e.g. sausages or burgers, then the cavities will be shaped accordingly.

The cavities may also be textured to provide surface features to the products formed, for example striations that correspond to the muscle fibres in whole meat cuts.

If a plurality of cavities (4) is used, then they may be of similar but different shapes and sizes to produce heterogenous product shapes which are more realistic for the consumer. The cavities may be coated with a release agent. The release agent may be temporary, such as an oil spray, preferably vegetable oil. The release agent may be more permanent, such as a Teflon coating applied to the cavities.

### Surface

The cavities (4) are recessed within the surface (5) of the forming element. The cavities may be positioned relative to one another such that they are sufficiently separated from each other to allow adequate surface (5) area for the sealing elements to interface with, that is to say that the gaps between the cavities should be greater than the length of cavities as measured in the direction of the movement of the nozzle element relative to the forming element.

### Interaction of Forming Element and Nozzle Element

The nozzle element and the forming element are moveable relative to each other.

A nozzle element can be movable across the surface (5) and cavities (4) of a stationary forming element; or a forming element can be moved while the nozzle element is stationary; or both the nozzle element and the forming element may be moveable.

Crucially, the nozzle element and forming element are moveable relative to each other such that the opening (1) of the nozzle element may come into register with the cavity or cavities (4) of the forming element. That is to say that the nozzle element can be moved into a position whereby the opening (1) is in the open configuration, and it is therefore able to fill a cavity (4).

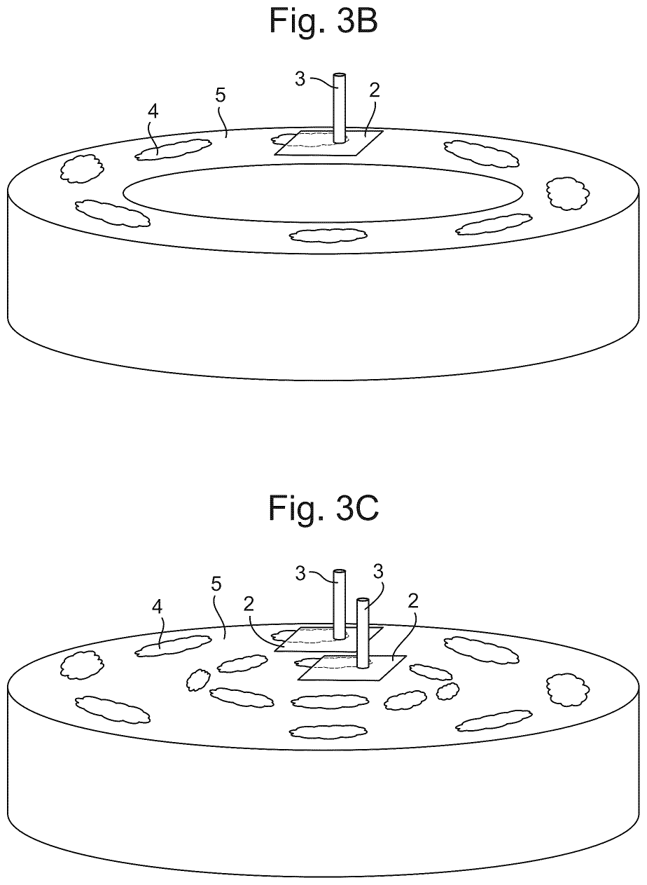

The apparatus can be configured in various different forms. FIG. 3 shows apparatuses configured for batch production. In FIG. 3 A) the forming element is in the form of a plate with a plurality of cavities. The nozzle and forming elements may be moved laterally relative to each other such that the opening (1) comes into register with the cavities (4). In FIG. 3 B) the apparatus is in the form of a carousel, with a forming element in the form of a circle having a plurality of cavities. The nozzle and forming elements may be moved relative to each other such that the opening (1) comes into register with the cavities (4), although in this configuration it would be simpler to rotate the forming element to bring the cavities (4) into position under the nozzle element. FIG. 3 C) shows an improvement to the version shown in FIG. 3 B) in which the forming element is in the form of a disc with a greater number of cavities arranged in a plurality of concentric circles with a plurality of nozzle elements, one for each concentric circle. Alternatively, one nozzle element with a plurality of openings may be used, or one nozzle element with a single opening capable of aligning with all the cavities may be used. As with the previous configuration, the nozzle elements and forming elements may be moved relative to each other but, again, it would be simpler to rotate the forming element to bring the cavities (4) into position under the nozzle elements. In these batch configurations, once all the cavities are filled then the forming element would need to be dissociated from the nozzle element and then manipulated such that the structured protein products can be removed from the cavities (4). For example, a human operator could manually remove the products from the cavities, or the forming elements could be inverted to allow the products to release from the cavities under the action of gravity.

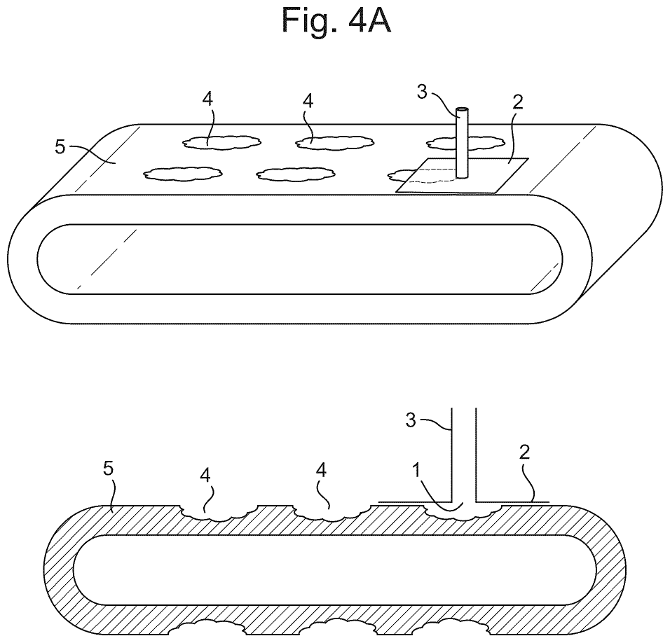

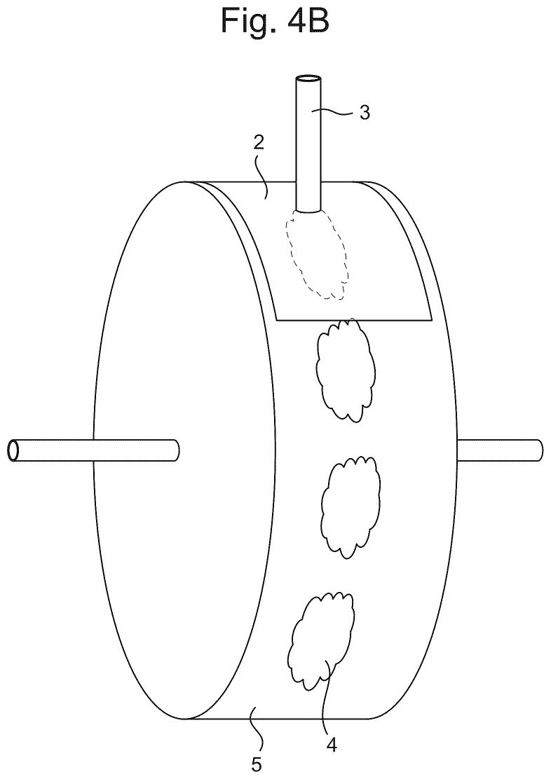

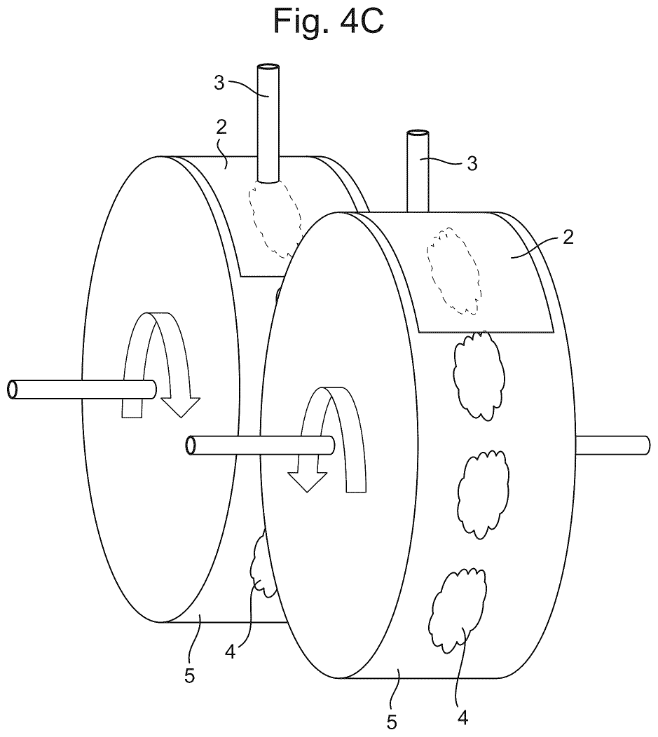

FIG. 4 shows apparatuses configured for continuous production. In FIG. 4 A) the forming element is in the form of a conveyer belt with a plurality of cavities. The apparatus is shown in perspective and in cross section. The forming element (IE the conveyer belt) can be operated such that the cavities are moved into register with the opening of the nozzle element. Typically, in such a set up the nozzle element would not be required to move. The filled cavities will proceed along the conveyer until they reach the end at which point the conveyer moves the cavity to an inverted position and the structured protein product can be easily removed from the cavity simply through the action of gravity. In FIG. 4 B), the forming element is in the form of a cylinder with a horizontal axis of rotation having a plurality of cavities located on the outer face of the cylinder. The forming element (IE the cylinder) is rotated such that the cavities are moved into register with the opening of the nozzle element. Typically, in such a set up the nozzle element would be positioned at the top of the apparatus and would not be required to move. The filled cavities then move past the nozzle element until they become inverted at which point the structured protein product can be easily removed from the cavities simply through the action of gravity. The nozzle element can include a sealing element which acts to seal the cavities until they reach the position at which the structured protein product is to be removed. In FIG. 4 C), the forming element comprises of a pair of interfacing cylinders, both with a horizontal axis of rotation and both having a plurality of cavities located on the outer face of the cylinder. The cavities of one forming element are designed to correspond to the cavities of the other forming element. The forming elements (IE the cylinders) are counter-rotated such that the cavities are moved into register with the opening of the nozzle elements. Typically, in such a set up the nozzle elements would be positioned at the top of the apparatus and would not be required to move. The filled cavities of each forming element then move past the nozzle elements until they meet their corresponding cavity on the other cylinder at the point where the outer surfaces of the cylinders interface. In this way a fully three-dimensional product can be formed whereby two halves of the structured protein product are provided by each of the two cavities and then joined together at the interface point. The nozzle elements can include sealing elements which act to seal the cavities until they reach the interface point. As the cavities move past the interface point, the structured protein product can be easily removed from the cavities simply through the action of gravity.

### Product Remover

The structured protein product may be removed from the cavities of the apparatus simply by inverting the cavities and allowing gravity to act upon the product. Additionally or alternatively the cavities may comprise removal means such as a mechanical pusher—EG a piston or an actuated plate—which forces the product from the cavity. The removal means may alternatively comprise means to inject a fluid, preferably a gas, into the cavity thereby to force the product from the cavity. Alternatively, the cavity can be formed from a deformable material such as a flexible plastic whereby a force such as gas pressure can be applied to the non-surface side of the cavity thereby to deform the cavity outwards towards, and even beyond, the surface of the forming element, thereby to dislodge the product from the cavity.

Following removal of the product from the cavity, the product can then be transported using suitable means such as a conveyer belt to any subsequent processing steps that might be required such as chilling, freezing, cooking, and the like.

### Protein-Containing Material

The process of the invention involves the step of pumping protein-containing material into the cavity (4) via the opening (1) thereby to form the structured protein product within the cavity (4).

### Protein

The protein-containing material preferably comprises from 1 to 65 wt % protein, more preferably 2 to 50 wt %, even more preferably 5 to 25 wt %, more preferably still 10 to 20 wt %, most preferably about 15 wt %.

The protein is from a non-animal source, preferably the protein is plant derived. The plant derived protein may be selected from the group consisting of legumes, soybean, sunflower, rapeseed, sesame, cottonseed, safflower, peas, lupins, peanuts, chickpeas, dry beans, lentils, dry peas (field peas), broad (fava) beans, pigeon peas, cowpeas, wheat, maize, rice, barley, rye, oat, sorghum, quinoa, canola, potato, cassava, sweet potato, cassava, amarant, sugar beet, aquatic plants, grape seed, tomato seed, papaya kernel. Preferably the plant protein is isolated from soybeans or corn, more preferably soybeans. A suitable soybean derived protein is texturized vegetable protein such as Fibertex (supplier: Gushen).

Preferably the protein has fibres with a length of from 0.1 to 15 cm, more preferably 0.2 to 10 cm, even more preferably 0.3 to 5 cm, most preferably 0.5 to 3 cm.

Preferably the protein has fibres with a width of from 0.01 to 2 mm, more preferably 0.05 to 1.5 mm, even more preferably 0.075 to 1 mm, most preferably about 0.1 to 0.5 mm.

### Water

In order to prepare the protein-containing material, the protein is hydrated. The protein-containing material therefore preferably comprises from 3 to 95 wt %, more preferably 5 to 75 wt %, even more preferably 10 to 50 wt %, more preferably still 15 to 40 wt %, most preferably about 25 wt % water.

### Protein:Water Ratio

Preferably the ratio of water to protein is from 1:5 to 10:1, more preferably from 1:2.5 to 7.5:1, more preferably still from 1:1 to 5:1, most preferably about 2:1.

### Binder

The protein-containing material may comprise a binder in order to bind the protein fibres.

Preferably the protein-containing material comprises from 1 to 20 wt % binder, more preferably from 2 to 15 wt %, more preferably still from 3 to 10 wt %, most preferably about 5 wt %.

Preferably the binder is methylcellulose, soy protein isolate, or a combination thereof.

### Oil/Fat

The protein-containing material may comprise fat or oil which may further enhance juiciness. Preferably the protein-containing material comprises from 0.5 to 15 wt % of fat or oil, more preferably from 1 to 10 wt %, more preferably still from 2.5 to 7.5 wt %, most preferably about 5 wt %.

The term “fat” as used herein refers to glycerides selected from triglycerides, diglycerides, monoglycerides, phosphoglycerides and combinations thereof. The term “fat” encompasses fats that are liquid at ambient temperature which are referred to herein as “oil” as well as fats that are solid or semi-solid at ambient temperature. The melting point of a fat can be determined according to ISO 6321 (2021).

The fat or oil may be selected from safflower oil, shea butter, allanblackia fat, linseed oil, castor oil, sunflower oil, soybean oil, rapeseed oil, olive oil, tung oil, cotton seed oil, peanut oil, palm kernel oil, coconut oil, cocoa butter, and palm oil. The fat may also be a mixture thereof.

Preferably the fat or oil is linseed oil, castor oil, sunflower oil, soybean oil, rapeseed oil, olive oil, tung oil, cotton seed oil, peanut oil, or a mixture thereof.

More preferably the fat or oil is linseed oil, castor oil, sunflower oil, soybean oil, rapeseed oil, olive oil, or a mixture thereof.

Most preferably the fat or oil is sunflower oil.

### Flavouring

The protein-containing material may comprise one or more additional flavours.

The additional flavours may comprise flavouring agents and/or flavour enhancers.

The flavouring agents may be natural or artificial. The flavouring agent may mimic or replace constituents found in meat tissues, such as, serum proteins, muscle proteins, hydrolyzed animal proteins, tallow, fatty acids, etc. The flavouring agent may provide an animal meat flavour, a grilled meat flavour, a rare beef flavour, etc. The flavouring agent may be an animal meat oil, oleoresins or aquaresins of spice extracts, spice oils, natural smoke solutions, natural smoke extracts, a yeast extract, or shiitake extract. Additional flavouring agents may include onion flavour, garlic flavour, or herb flavours.

The protein-containing material may further comprise a flavour enhancer. Examples of flavour enhancers that may be used include salt (sodium chloride), glutamic acid salts (e.g., monosodium glutamate), glycine salts, guanylic acid salts, inosinic acid salts, 5′-ribonucleotide salts, hydrolyzed animal proteins, and hydrolyzed vegetable proteins.

Preferably the protein-containing material comprises additional flavours in an amount of from 1 to 10 wt %, more preferably from 2 to 8 wt %, more preferably still from 4 to 6 wt %, most preferably about 5 wt %.

### Fibre

The protein-containing material may also comprise non-protein fibre. Suitable fibres include cellulose, noncellulosic polysaccharides such as hemicellulose, and non-carbohydrate component lignin. Sources of cellulose fibres are vegetables, sugar beet and various brans. Hemicellulose can be obtained from cereal grains. Lignin can be derived from woody plants. Examples include insoluble fibres from potato, oat, pea and citrus, apple, psyllium, fenugreek, carrot and inulin. Preferably the fibre is oat fibre. It is believed that the fibre acts to retain the foregoing flavour agents where used.

Preferably the protein-containing material comprises non-protein fibre in an amount of from 0.2 to 5 wt %, more preferably from 0.5 to 4 wt %, more preferably still from 1 to 3 wt %, most preferably about 2 wt %.

The protein-coating material may also be known as a composition comprising protein.

In an embodiment of the invention the protein-containing material (composition comprising protein) comprises one or more ingredient selected from protein, water, binder, oil/fat, flavouring and fibre.

In an embodiment of the invention the protein-containing material (composition comprising protein) comprises protein, water, binder, oil/fat, flavouring and fibre.

In an embodiment of the invention the protein-containing material (composition comprising protein) comprises:
a. from 1 wt % to 65 wt % protein,
b. from 3 wt % to 95 wt % water,
c. from 1 wt % to 20 wt % binder
d. from 0.5 to 15 wt % of fat
e. from 1 to 10 wt % flavouring,
f. from 0.2 to 5 wt % fibre.

The protein-containing material (composition comprising protein) ingredients are selected from the group consisting of protein, water, binder, oil/fat, flavouring, fibre and mixtures thereof.

### Processing of Protein-Containing Material

The protein-containing material may be formed into any suitable form for use in the process of the invention. Typically, it will be formed into a pumpable form, such as a fibrous dough. Any form of processing known to the skilled person may be employed to provide the protein-containing material.

It is preferred that the components of the protein-containing material are processed in such a way that the protein fibres therein are not adversely impacted. For example, the components of the protein-containing material are combined under low shear and/or with low energy input in order to maintain the length of the protein fibres.

### Hydration of Protein

The protein, preferably texturized vegetable protein, may be gently hydrated in the presence of the water. Gentle hydration may be achieved for example by placing the protein and the hydrating water in the bowl of a bowl chopper with very blunt paddles constructed with plates of metal having a squared edge, and no sharp aspects. Such processing results in hydrated protein which may solely comprise the protein-containing material and therefore be used in the process of the invention. However, as mentioned above, it may be desired to include further ingredients in the protein-containing material.

### Binder and Oil/Fat

If used, the binder and oil/fat may be mixed in a blender under very high energy whereby they combine to form a pre-emulsion. The protein is not included in this step because to do so would destroy the protein fibres, resulting in a paste as opposed to the desired fibrous dough.

### Non-Protein Fibres and Flavours

If used, the dry ingredients of the non-protein fibres and flavours may be premixed, added to the aforementioned pre-emulsion, and combined with the pre-emulsion under conditions of very high energy. This results in a flavoured emulsion which may then be gently combined with the hydrated protein thereby to form the protein-containing material for use in the process of the invention. The use of this high energy processing has been found to result in a firmer structured protein product due to the fine pre-emulsion formed during the preparation of the protein-containing material.

Alternatively, the pre-emulsion, the premixed dry ingredients of the non-protein fibres and flavours, and the hydrated protein may be gently combined together using, for example, the aforementioned a bowl chopper as used for hydrating the protein. It has been found that this lower energy approach results in a softer protein-containing material to be used in the process of the invention and without wishing to be bound by theory it is believed that a low viscosity material of this type is a preferable matrix for the protein fibres to be able to move and align within.

It will be appreciated that the protein-containing material thus formed may be in the form of a dough, preferably a fibrous dough. The protein-containing material is pumpable.

### Process for the Production of the Structured Protein Product

In the process of the present invention the nozzle element and forming element are moved relative to each other such that the opening (1) comes into at least partial alignment with a cavity (4). The opening (1) therefore moves from a closed configuration (in which it was blocked by the surface (5)) to an open configuration. The protein-containing material is then pumped into the cavity (4) via the opening (1) thereby to form the structured protein product within the cavity (4). It has surprisingly been found that as the protein-containing material passes through the opening into the cavity, excellent fibre alignment is achieved within the cavity.

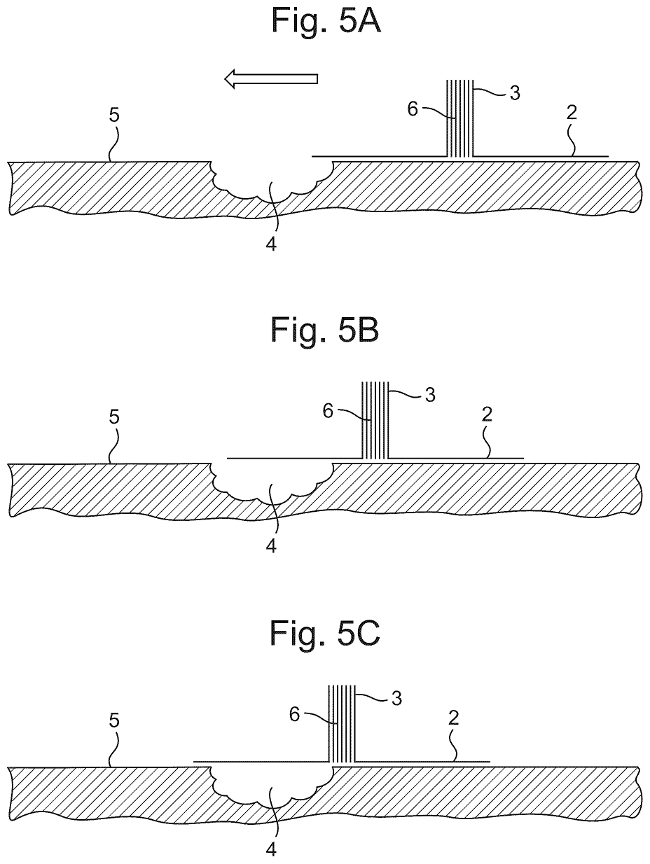

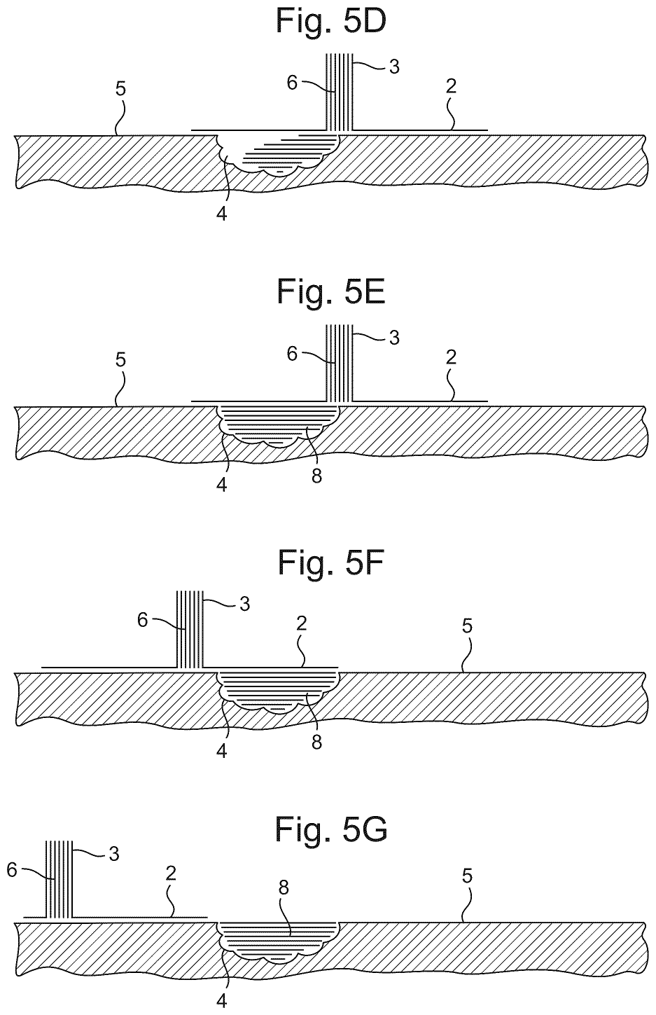

FIG. 5 exemplifies the process of the invention. In FIG. 5 the nozzle element moves relative to the forming element in the direction of the arrow.
FIG. 5 A) shows the nozzle element positioned upstream of the forming element and the cavity (4) is uncovered. Although the protein-containing material (6) is being pumped towards the opening (1), the opening (1) remains in contact with the forming element surface (5) and is therefore in the closed configuration, hence the protein-containing material (6) is retained in the nozzle element.
As shown in FIG. 5 B), as the nozzle element moves towards the cavity, the sealing element (3) begins to cover the cavity but the opening (1) remains in the closed configuration.
In FIG. 5 C), the cavity is completely sealed by the sealing element (3) but the opening (1) remains in the closed configuration.
In FIG. 5 D), the opening (1) has moved away from the surface (5) of the forming element and into partial alignment with the cavity (4). The opening (1) is therefore in the open configuration. The protein-containing material (6) can no longer be retained in the nozzle element and is able to flow into the cavity (4) under pressure. At this stage, it has surprisingly been found that the protein fibres (7) in the protein-containing material (6) are aligned.
As shown in FIG. 5 E), the cavity rapidly fills with the protein-containing material (6), the fibres are aligned, and thereby the structured protein product (8) is formed within the cavity (4). At this point, the pressure in the cavity is equal to the pressure of pumping and the flow of protein-containing material (6) into the cavity stops. However, the pressure serves to hold the protein fibres (7) in alignment, further assuring the quality of the structured protein product (8).
FIG. 5 F) shows the nozzle element having passed further over the cavity (4) such that the opening is in the closed configuration but the cavity is still sealed by the sealing element (3) and the structured protein product (8) is still retained within. Once the nozzle element has fully passed over the cavity (4) as shown in FIG. 5 G), then the structured protein product (8) may be removed from the cavity (4).

### Pumping Protein-Containing Material

As detailed above, the protein-containing material is pumped into the cavity via the opening in the nozzle element. Any suitable apparatus may be used for this purpose provided it is capable of moving the protein-containing material from an upstream location, such a mixer, or storage tank, via suitable conduits, to the opening such that it arrives at the opening under pressure. Various pumps may be employed, but positive-displacement pumps are preferred. The pump may be a: Rotary-type positive displacement pump (such as an internal or external gear pump, screw pump, lobe pump, shuttle block, flexible vane or sliding vane, circumferential piston, flexible impeller, helical twisted roots or liquid-ring pumps); a Reciprocating-type positive displacement (such as piston pumps, plunger pumps or diaphragm pumps); or Linear-type positive displacement (such as rope pumps and chain pumps). Extruders, such as single or double screw extruders may also be used to move the protein-containing material to the opening.

The temperature of the protein-containing material may be controlled to ensure that the material has the required consistency and/or viscosity in order to be liquid enough for pumpability but firm enough to retain its shape and hold fibres in alignment when dosed into the cavity.

### Properties of the Structured Protein Product

As detailed above, the process of the invention is uniquely capable of providing a structured protein product having aligned fibres.

### Fibre Alignment

In the context of this invention aligned fibres means that the protein fibres forming the structured protein product are contiguous to each other at less than a 45 degree angle when viewed in a plane, preferably less than 40 degrees, more preferably less than 30 degrees, more preferably still less than 20 degrees, even more preferably less than 10 degrees, most preferably less than 5 degrees.

Preferably at least 25% of the protein fibres are contiguous to each other, more preferably at least 50%, more preferably still at least 60%, even more preferably at least 70%, yet more preferably still at least 80%, even more preferably still at least 90%, most preferably at least 95%.

Methods for determining the degree of protein fibre alignment are known to the skilled person and include quantitative determinations based upon visual or automated analysis of images of the relevant structure or product. The structured protein products formed from the process of the present invention generally have the texture and consistency of animal meat. In contrast, traditional extrudates having protein fibres that are not aligned, i.e. that are randomly oriented, generally have a texture that unacceptable. For example, it can lack the firmness expected, does not yield the same mouthfeel upon chewing, and does not behave in the required way during cooking.

### Shear Strength

In addition to having protein fibres that are aligned, the structured protein products formed by the process of the present invention also have similar shear strength to whole meat muscle. As used herein, the term shear strength provides an approach to quantify the ability of the process of the invention to deliver whole-muscle like texture and appearance to the structured protein product.

As used herein, shear strength means the maximum force needed to shear through a given sample. Shear strength of a sample is measured in grams and may be determined by: Weighing a sample of the structured protein product; Placing the sample in a heat sealable pouch; Adding approximately three times the sample weight of water; Evacuating the pouch to a pressure of about 0.01 Bar and sealing the pouch; Allowing the sample to hydrate for about 12 to 24 hours; Removing the hydrated sample and placing it on a texture analyser base plate oriented so that the knife from the texture analyser cuts through the diameter of the sample (the sample being oriented such that the knife cuts perpendicular to the long axis of the textured piece). A suitable knife is a model TA-45, incisor blade manufactured by Texture Technologies (USA). A suitable texture analyser is a model TA, TXT2 manufactured by Stable Micro Systems Ltd. (England) equipped with a 25, 50, or 100 kilogram load. Shear strength is thus quantified as the maximum force in grams needed to shear through the sample.

The structured protein products produced by the process of the present invention preferably have an average shear strength of at least 250 g, more preferably at least 500 g, more preferably still at least 750 g, even more preferably at least 1000 g, yet more preferably still at least 1250 g, even more preferably still at least 1500 g, most preferably at least 2000 g.

### Fibre Size

The protein fibres formed in the structured protein products may be determined using a shred characterization test which is able to determine the percentage of large pieces formed in the structured protein product. Percentage shred characterization may also be used as a proxy measure to quantify the degree of protein fibre alignment in a structured protein product—as the percentage of large pieces increases, the degree of protein fibres that are aligned within the structured protein product also increases. Conversely, as the percentage of large pieces decreases, the degree of protein fibres that are aligned within the structured protein product decreases.

A method for determining shred characterization is as follows: Place a 150 g sample into a heat-sealable plastic bag, add 450 g of water at 25° C., vacuum seal the bag at about 150 mm Hg, allow contents to hydrate for about 1 hour; Place hydrated sample in the bowl of a mixer (e.g. Kitchen Aid mixer model KM14G0 equipped with a single blade paddle) and mix contents at 130 rpm for two minutes; Scrape paddle and bowl, returning scrapings to bottom of the bowl; Repeat mixing and scraping twice, Remove 200 g of mixture from the bowl; Segregate all fibres or long strands longer than 2.5 cm from shredded mixture; Weigh segregated fibres and divide this weight by starting weight (200 g) to determine the % of large pieces in the sample.

The structured protein products achieved from the process of the invention preferably have an average shred characterization of at least 10% by weight of large pieces, more preferably at least 12%, more preferably still at least 14%, even more preferably at least 16%, yet more preferably still at least 18%, even more preferably still at least 20%, most preferably at least 25%.

### Fibre Length Maintenance Parameter

As set out in the foregoing, the process of the invention is capable of creating a structured protein product having aligned fibres and properties analogous to animal muscle tissue. In addition the process is capable of ensuring that the protein fibres in the protein-containing material are not negatively impacted by the processing. This is in contrast to other processes which, as demonstrated in the Examples below, cause damage to the protein fibres which are broken and shortened and therefore less able to deliver properties analogous to animal muscle tissue. The damage to the protein fibres can be calculated by utilizing methods know to the skilled person, such as those set out above, to measure the length of the protein fibres before processing and in the final product. This calculation is referred to herein as the Fiber Length Maintenance Parameter (FLMP) and is calculated by:
Measuring the average protein fibre length of the protein-containing material [before filling cavity]—referred to as “A”;
Measuring the average protein fibre length of the structured protein product referred to as “B”; and where

$$F L M P = B / A .$$

Preferably FLMP is at least 0.5, more preferably at least 0.6, more preferably still at least 0.7, even more preferably at least 0.8, yet more preferably still at least 0.9, even more preferably still at least 0.95, most preferably at least 0.99.

### Fibre Length Increase Parameter

As foreshadowed above, the process of the invention is actually capable of increasing the length of the protein fibres. Without wishing to be bound by theory, it is hypothesized that the process of the invention uniquely teases apart or mildly disaggregates uneven macro-molecular structures or complexes in the protein fibres, thereby actually increasing the length of the protein fibres. The increase in the protein fibre length can again be calculated by utilizing methods know to the skilled person, such as those set out above, to measure the length of the protein fibres before processing and in the final product. In this instance the calculation is referred to herein as the Fiber Length Increase Parameter (FLIP) and is calculated in a similar way top FLMP by:
Measuring the average protein fibre length of the protein-containing material [before filling cavity] referred to as “C”;
Measuring the average protein fibre length of the structured protein product referred to as “D”; and where

$$F L I P = D / C .$$

Preferably FLIP is at least 1, more preferably at least 1.1, more preferably still at least 1.2, even more preferably at least 1.3, yet more preferably still at least 1.4, most preferably at least 1.5.

### Subsequent Processing Steps

Once the structured protein product is removed from the cavity, it may then be subjected to further processing steps. Ideally, the product will be treated in such a way as to fix or stabilize the unique aligned protein structure that is achieved in the process of the invention. The product may be frozen. The product may also or additionally be cooked in which any form of appropriate subjection to heat (for example boil, fry, broil, grill, oven, microwave, and the like) may be used. The product thus formed may then be packaged and transported to the consumer. The consumer may then either cook or reheat the product again, slice it to form cold cut, utilize it as a cooked meat in a salad, fry, shred the product into soup or a stew, or any such use as may be desired by the consumer for this meat replacement product.

### Product by Process

As will be appreciated, the process of the present invention provides a uniquely structured product with distinct physical and organoleptic properties that result from the process. The present invention therefore also provides the structured protein product that is directly obtained from the process of the invention.

### Use of Product of Process for Manufacture of Meat Replacement Products

The said structured protein product directly obtained from the process of the invention may be used with other product components such as fat components, coatings, further structured protein products and so on, thereby to produce additional and distinct meat replacement products. The present invention therefore also provides for such a use and provides said meat replacement products comprising the above product structured protein product directly obtained from the process.

As used herein the term “comprising” encompasses the terms “consisting essentially of” and “consisting of”. Where the term “comprising” is used, the listed steps or options need not be exhaustive.

Unless otherwise specified, numerical ranges expressed in the format “from x to y” are understood to include x and y. In specifying any range of values or amounts, any particular upper value or amount can be associated with any particular lower value or amount.

Except in the examples and comparative experiments, or where otherwise explicitly indicated, all numbers are to be understood as modified by the word “about”.

All percentages and ratios contained herein are calculated by weight unless otherwise indicated.

As used herein, the indefinite article “a” or “an” and its corresponding definite article “the” means at least one, or one or more, unless specified otherwise.

The various features of the present invention referred to in individual sections above apply, as appropriate, to other sections mutatis mutandis. Consequently, features specified in one section may be combined with features specified in other sections as appropriate. Any section headings are added for convenience only and are not intended to limit the disclosure in any way.

The invention will be further set out in the following examples. The examples are intended to illustrate the invention and are not intended to limit the invention to those examples per se.

### Examples

An exemplary protein-containing material was made and subjected to various processing approaches as set out below.

### Formulation

The following table provides the formulation of the protein-containing material.

| Ingredient | wt % | Supplier |
|---|---|---|
| Protein (Texturized Vegetable Protein, Fibertex) | 14.45 | Gushen |
| Water (to Hydrate Protein) | 24.56 | n/a |
| Binder (Methocel Bind 250 DowDupont (433026)) | 1.83 | IFF |
| Binder (Soy protein isolate (EX 37)) | 3.85 | Solae/IFF |
| Crushed ice | 9.63 | n/a |
| Water (4° C.) | 34.0 | n/a |
| Oil (Sunflower oil) | 5.30 | Thywissen |
| Non-Protein Fiber (Oat Fiber VITACEL ® HF 200) | 1.93 | Rettenmaier |
| Flavours | 4.45 | Givaudan, |
| | | Ingredion |

### Processing of Protein-Containing Material

The Texturized Vegetable Protein was gently mixed in presence of the water (to hydrate protein) in a bowl chopper with very blunt blades constructed of plates of metal with a squared edge and no sharp aspects. This resulted in the hydrated protein component.

The binders, oil and additional water (Crushed Ice and 4° C.) were blended to form the pre-emulsion component.

The Non-Protein Fiber and the Flavours were premixed and then blended with the pre-emulsion component to form the flavoured emulsion.

The hydrated protein and flavoured emulsion components were gently mixed in the bowl chopper thereby to form the protein-containing material.

### Production of Products

The resulting protein-containing material was used to, or attempted to use to, create a variety of structured protein products as follows:

### Sample A:

A Handtmann vane pump was used to pump the protein-containing material through sausage stuffing tubes with 25 mm or 20 mm diameter. It was found that the tubes acted to align the protein fibres and the protein-containing material that exited the tubes was of a fibrous and acceptable structure. However, the extruded material had to be manually handled with extreme and exacting care to ensure that the aligned structure from the process could be maintained. Despite this care, it was not possible to then use the extruded material to make a final product.

### Sample B:

A Netzschpump comprising a screw feeder pump followed by a positive displacement pump was used to process the protein-containing material. However, although the protein fibres were visible in the product obtained, they were not aligned.

### Sample C:

A Netzschpump comprising a screw feeder pump followed by a positive displacement pump was again used but with the addition of a breaker plate to create a laminar flow in order to align the protein fibres. However, it was found that the protein fibres were destroyed by this additional component and structured protein products could not be formed.

### Sample 1:

Sample 1 is according to the invention. An apparatus comprising a forming element in the form of a rotating cylinder having four rows of chicken breast fillet shaped cavities and a nozzle element with an opening spanning all four rows was used. The protein-containing material was pumped into a conduit leading to the opening which, as soon as it became partially aligned with the cavities, allowed the cavities to be filled.

The resultant structured protein products showed excellent alignment of the protein fibres, and moreover retained their shape well upon removal from the cavities.

### Fibre Length Analysis

6 g samples were obtained from the following formats:
Hydrated TVP (as described above)
Protein-containing material (from Sample 1)
Cooked structured protein product (from Sample 1)

Fibres were removed from the sample by repeated (×3) washing with water and ethanol, a vacuum was applied twice, and the fibres were subjected to stirring in a beaker of water for approximately an hour to allow the fibres to be separated. Individual fibres were then removed, placed on black paper, and Photographed with DigiEye. The resulting images were analyses using ImageJ to determine the fibre length.

It was found that the Hydrated TVP and Cooked structured protein product has almost the same average protein fibre length (3.97 mm and 3.92 mm respectively). The Protein-containing material actually had an average fibre length of 5.2 mm.

1. A process for the production of a structured protein product using an apparatus, the apparatus comprising a nozzle element and a forming element wherein:
i) the nozzle element comprises an opening;
ii) the forming element comprises one or more cavities recessed relative to the forming element surface; and
iii) the nozzle element and forming element are moveable relative to each other such that
in a closed configuration, the opening is blocked by the surface, and
in an open configuration, the opening is at least partially aligned with a cavity, the process comprising the steps of:
a) moving the nozzle element and forming element relative to each other such that the opening comes into at least partial alignment with the one or more cavities thereby to configure the opening in the open configuration;
b) pumping a protein-containing material into the cavity via the opening thereby to form the structured protein product within the cavity;
c) moving the nozzle element and forming element relative to each other such that the opening comes into alignment with the surface of the forming element thereby to configure the opening in the closed configuration; and then d) removing the structured protein product from the cavity.

2. The process according to claim 1 wherein the opening has an aspect ratio of from 1:100 to 100:1.

3. The process according to claim 1, wherein the width of the opening is at least 100% of the widest part of the cavity of the forming element.

4. The process according to claim 1, wherein the nozzle element comprises a sealing element.

5. The process according to claim 1, wherein the forming element is in the form of a cylinder with a horizontal axis of rotation having a plurality of cavities located on the outer face of the cylinder.

6. The process according to claim 1, wherein the protein-containing material comprises from 1 to 65 wt % protein.

7. The process according to claim 1, wherein the protein-containing material comprises no animal protein.

8. The process according to claim 1, wherein the protein-containing material comprises from 1 to 20 wt % binder.

9. The process according to claim 1, wherein the protein-containing material comprises from 0.5 to 15 wt % of fat or oil.

10. The process according to claim 1, wherein the protein fibres forming the structured protein product are contiguous to each other at less than approximately a 45 degree angle.

11. The process according to claim 10 wherein at least 25% of the protein fibres are contiguous to each other.

12. The structured protein product directly obtained from the process according to claim 1.

13. (canceled)

14. A meat replacement product comprising the product of claim 12.
